(19) United States
(12) Patent Application Publication
(10) Pub. No.: US 2015/0355377 A1
(43) Pub. Date: Dec. 10, 2015

(54) CONFIGURABLE OPTICAL COUPLERS

(71) Applicant: Empire Technology Development LLC, Wilmington, DE (US)

(72) Inventors: Seth Adrian Miller, Longmont, CO (US); Gary Lynn Duerksen, Ward, CO (US)

(21) Appl. No.: 14/298,382

(22) Filed: Jun. 6, 2014

(51) Int. Cl. G02B 1/04; G02B 6/42

(52) U.S. Cl. CPC G02B 1/04; G02B 6/4266

(57) ABSTRACT

Systems and methods to generate and reconfigure optical components are provided. A composition is provided that includes monomers that are activated by different polymerization mechanisms. A first monomer is polymerized to form an optical component in the composition. The optical component thus formed is reconfigured and the second monomer in the composition is then polymerized to fix the composition.

### TECHNICAL FIELD

The present disclosure generally but not exclusively relates to optical components and to optical components that can be formed and reconfigured in optoelectronic systems.

### BACKGROUND

Unless otherwise indicated herein, the materials described in this section are not prior art to the claims in this application and are not admitted to be prior art by inclusion in this section.

There are many devices that have both optical and electrical components (optoelectronic devices). In optoelectronic devices, the ability to direct and process optical signals can be a substantive part of such devices. As a result, it may be useful to test the optical operation of these devices during manufacture. Unfortunately, procedures such as testing the optical aspects of optoelectronic devices can be problematic.

More specifically, it may be useful to couple optical signals into and out of the optoelectronic devices in order to test or verify optical connectivity and operation of the optoelectronic devices. In order to perform these tasks, an off-board optical access port for the optical signals or “test point” on the optical backplane may be used in testing and verifying the devices and interconnects. An optical test point has a cost, however, that is distinct from electrical test points.

While an electrical port with an open/impedance-matched termination may not significantly interfere with the operation of an electronic device when the electrical access port is not connected, an optical access port may impact the normal operation of the optoelectronic device after the optical test point has been used for test or verification purposes. The performance of optoelectronic devices will be reduced as a result of the presence of optical access ports in the optical backplane.

### SUMMARY

An illustrative embodiment disclosed herein relates to a material system. The material system may include a gellant agent, a first monomer, and a second monomer. The first monomer can be polymerized into a first polymer by a first polymerization mechanism and the second monomer can be polymerized into a second polymer by a second polymerization mechanism. The gellant agent, the first monomer, and the second monomer may be mixed in a composition.

An illustrative embodiment disclosed herein relates to a configurable structure in an optical waveguide. The optical structure may include a nanopartical gellant, a first monomer that may be polymerizable by a first mechanism and a second monomer that may be polymerizable by a second mechanism. The first monomer, the second monomer and the nanoparticle gellant may be mixed to form a composition that is configured to form the optical component in response to exposure to the first polymerization mechanism. Exposure to the first polymerization mechanism can generate a modulated refractive index in the optical component. The optical component may melt in response to exposure to a temperature such that the composition reflows and the optical component is removed or such that the modulated refractive index is removed and such that the composition includes an average refractive index. The composition may then be exposed to the second polymerization mechanism that fixes the composition and forms a permanent structure. The second polymerization mechanism may be optical or thermal. The optical component may be formed as a layer on an optical waveguide or similar structure.

An illustrative embodiment disclosed herein relates to an apparatus that includes a substrate, an optical waveguide formed on a surface of the substrate, and a reconfigurable optical component that may be formed on the optical waveguide. The reconfigurable optical component may include a composition that may include a first monomer, a second monomer, and a nanoparticle gellant. The composition is configured to form an optical component that includes a modulated refractive index in response to exposure to a first temperature and a first wavelength of structured light. The first wavelength of light may cause the first monomer to polymerize in a manner that forms an optical component that includes the modulated refractive index. The optical component can be reconfigured in response to a second temperature that is higher than the first temperature such that the modulated refractive index is removed and the optical component includes an average refractive index.

An illustrative embodiment disclosed herein relates to a method to form a reconfigurable optical component in an optical backplane or in an optical waveguide. A composition that includes a first monomer and a second monomer may be deposited on a substrate. The composition may be exposed to a wavelength of structured light that polymerizes the first monomer into a first polymer and forms an optical component that includes a modulated refractive index. The optical component can be reconfigured by exposure to a temperate that melts the first polymer such that the composition reflows. When the composition reflows, the modulated refractive index is removed. The composition can be fixed by polymerization of the second monomer.

An illustrative embodiment disclosed herein relates to a method to test an optoelectronic system. A pattern may be written in a composition with structured light to form an optical component in a waveguide. The composition may include a first monomer and a second monomer and a gellant agent. An optical component that includes a modulated refractive index may be generated when the pattern is written in the composition. The optoelectronic system may be tested through the optical component formed in the composition. After testing or other procedures are completed, the optical component may be annealed to reconfigure the optical component to remove the modulated refractive index. The composition may then be fixed by polymerization of the second monomer.

An illustrative embodiment disclosed herein relates to a method to form a reconfigurable optical component in an optoelectronic system. A composition that includes a first monomer, a second monomer and a nanoparticle gellant may be deposited on a substrate. The composition may be exposed to a first wavelength of structured light that polymerizes the first monomer into a first polymer such that an optical component is formed in the composition such that the optical component includes a modulated refractive index. The optical component may be reconfigured by exposure of the optical component to a first temperature in order to melt and disperse first polymer within the composition such that the modulated refractive index is removed and the composition includes an average refractive index. The composition may be fixed by polymerization of the second monomer.

The optoelectronic system may be tested by introduction of optical signals into the optoelectronic system through the optical component before reconfiguring the optical component.

In one example, an optical coupler, a grating structure or a waveguide may be formed with the first wavelength of the structured light.

In one example, the composition may be fixed by exposure to a second wavelength of light while the composition is at the first temperature. The second wavelength of light polymerizes the second monomer. Alternatively or in addition, the composition may also be fixed by exposure to a second temperature that is higher than the first temperature. The second monomer may polymerize at the second temperature.

An illustrative embodiment disclosed herein relates to a method to test an optoelectronic system. A pattern may be written in a composition with structured light to form an optical component in the composition. The composition may be formed over a substrate and the composition may include a first monomer, a second monomer, and a nanoparticle gellant. A modulated refractive index may be generated in the composition when the structured light polymerizes the first monomer into a first polymer. The optoelectronic system may be tested through the optical component formed in the composition. The composition may be annealed such that the modulated refractive index is removed and the optical component is reconfigured. The composition may be fixed by polymerization of the second monomer. The fixed composition may have an average refractive index.

In one example, the pattern may be written by exposure of the composition to a first temperature. Also, the composition may be annealed by exposure of the composition to a second temperature that is higher than the first temperature. The first polymer may melt at the second temperature and may disperse in the composition with the second monomer such that the composition has the average refractive index.

The composition may be fixed by exposure of the composition to a third temperature. The second monomer may polymerize at the third temperature to permanently fix the composition. Alternatively or in addition, the composition may be fixed by exposure of the composition a second wavelength of light at a second temperature. The second wavelength of light may polymerize the second monomer.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1A illustrates an example of a material system that enables an optical component formed from or in the material system to be reconfigured.

FIG. 1B illustrates an example of a structure that includes an optical component that has been formed from the material system illustrated in FIG. 1A.

FIG. 1C illustrates an example of the material system in FIG. 1B after the optical component has been reconfigured.

FIG. 2 illustrates an example of an optoelectronic device that includes a reconfigurable or an erasable optical component.

FIG. 3 illustrates an example of a system that transforms a material system into an intermediate structure that includes an optical component and then into a fixed structure where the optical component has been reconfigured.

FIG. 4 illustrates an example of a configurable optical structure.

FIG. 5 illustrates an example of a system to form and to reconfigure optical components in a device such as an optoelectronic device.

FIG. 6 illustrates a flow diagram of an embodiment of a method to form and then reconfigure an optical component in a layer of an optoelectronic device.

FIG. 7 illustrates a flow diagram of an embodiment of a method to test an optoelectronic system.

FIG. 8 shows an example computing device that is configured to form and to reconfigure optical components in an optoelectronic system.

All of the above are arranged according to at least some embodiments presented herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the figures, can be arranged, substituted, combined, separated, and designed in a wide variety of different configurations, all of which are explicitly contemplated herein.

Devices or structures such as optoelectronic devices may use both optical signals and electrical signals. For such devices to operate properly, a number of procedures should be performed during manufacture. For example, electro-optical components should be optically aligned with the optical interconnects on an optical backplane or in a waveguide. Verification and testing of the electrical/optical circuit integration should be performed at various stages of the manufacture process. It may be useful to filter or block components of an optical signal from reaching certain components, insert test signals to interrogate those components, or extract the optical signals from certain components after applying a test electrical signal.

In order to perform these types of procedures, off-board interfaces or test points that allow optical signals to be introduced into the device and that allow optical signals to be extracted from the device may be useful. Access ports for electrical signals differ from access ports for optical signals. Access ports for electrical signals may have a high impedance and may not significantly interfere with the operation or function of the device when not connected. Access ports for optical signals, in contrast, can impact the operation of the device even when the access ports are not connected.

This disclosure is generally drawn, inter alia, to methods, apparatus, systems, devices, and computer program products related to reconfigurable optical components.

Briefly stated, embodiments relate to systems and methods to generate and reconfigure optical structures or components such as off-plane optical couplers are provided. A composition is provided that includes monomers that are activated by polymerization mechanisms. The monomers in a composition may be activated by similar or different polymerization mechanisms. A first monomer is polymerized to form an optical component in the composition. The optical component thus formed may be reconfigured and the second monomer in the composition may then be polymerized to fix the composition or make the composition permanent.

Embodiments relate to systems and methods that allow optical components to be formed within optical interconnects such that devices or optical and/or electrical components thereof can be tested or verified or such that other procedures can be performed on a circuit board or other substrate. In some examples, the optical components disclosed herein can become a permanent component of the device. After the testing, verification or other procedure is completed, embodiments of the optical components can be removed or erased. This allows the optical components that are used as optical test points, for example, to not impact (or to have reduced impact on) the operation or performance of the device once the access ports are no longer used. Embodiments may also relate to configurable optical components that are an integral part of the circuit rather than for testing or validating the circuit or connected devices.

Embodiments relate to optical components including reconfigurable, erasable or removable components for, by way of example, integration and verification of optical interconnects in structures such as optoelectronic devices. Optoelectronic devices and systems include, by way of example, printed circuit boards, integrated circuits, optical layers of a device, optical planes, waveguide structures, or the like or combination thereof.

Embodiments relate to material systems that are reconfigurable and that are capable of large refractive index modulation and low optical losses. The material system can be configured into optical components such as a grating structure or waveguide and then reconfigured.

A composition may be an example of a material system. An example of a composition may include monomers that can be polymerized by different polymerization mechanisms. Some monomers may be polymerized by certain wavelengths of light (optically initiated polymerization) while other monomers may be polymerized by heat (thermally initiated polymerization). By forming an optical component from a composition that includes monomers that are responsive to different polymerization mechanisms, the optical component can be formed in the composition and then reconfigured or removed.

In one example, a first monomer can be polymerized or selectively polymerized by a first polymerization mechanism to form an optical component (e.g., an index-modulation volume (such as a grating or a waveguide grating)). The optical component formed in response to the first polymerization mechanism can then be reconfigured by heat, which allows material of the optical component to reflow. After the optical component has been reconfigured or changed, the composition can be fixed by a second polymerization mechanism that polymerizes the second monomer in the composition.

When an optical component such as a grating structure is formed, the first polymerization mechanism may polymerize a portion of the composition to generate a structure that includes a modulated refractive index. Heating such a structure can melt at least the polymerized portion of the structure such that the modulated refractive index is removed as the structure reflows or mixes. The second polymerization mechanism may permanently fix the structure by polymerizing another portion of the composition. This allows the optical component to be present for certain procedures and then removed or erased when no longer needed. Removing the optical component prevents the optical component from interfering with the operation of the apparatus in which the optical component was temporarily formed.

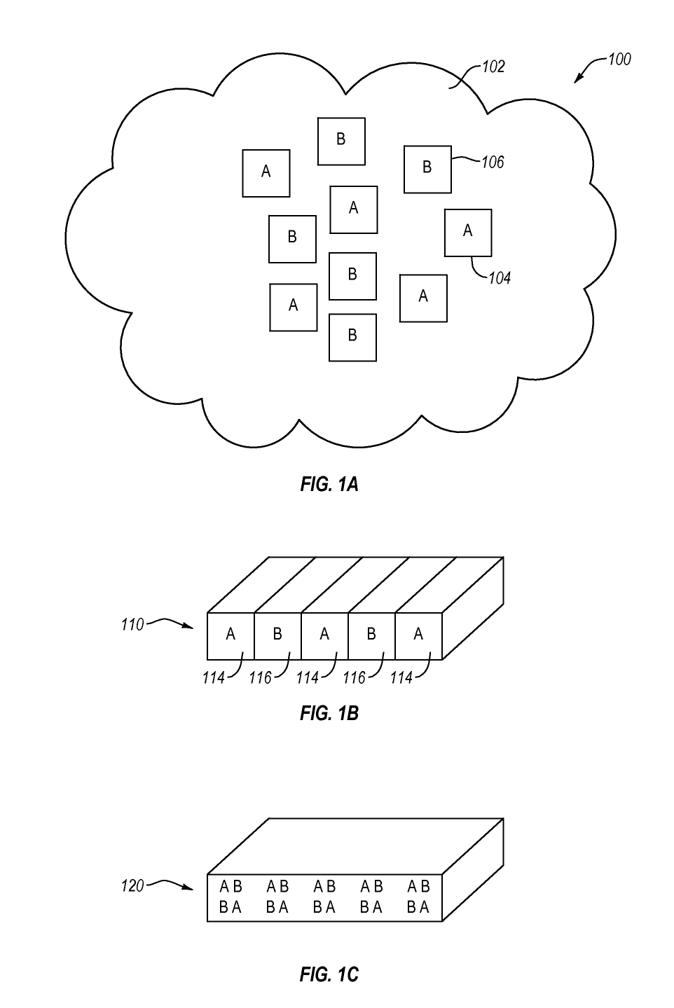

FIG. 1A illustrates an example of a material system that enables an optical component formed from or in the material system to be reconfigured. FIG. 1A illustrates an example of a composition 100, which is an example of a material system. The composition 100 may include a monomer 104 and a monomer 106 and a mixture 102. The monomers 104 and 106 may be carried in the mixture 102. The mixture 102 may include a nanoparticle gellant or other gelling agent. The mixture 102 may include a carrier solvent and fumed silica or other appropriate material.

The monomers 104 and 106 may each be associated with initiators that allow the monomers 104 and 106 to be polymerized. The monomer 104 and 106 may be, in one example, polymerized by a thermal mechanism or an optical mechanism. In addition, the refractive index of the monomer 104 may be higher than the refractive index of the monomer 106. In one example, the monomer that is polymerized by a first polymerization mechanism has a higher refractive index. However, the monomer that has the lower refractive index may be polymerized by the first polymerization mechanism.

The composition 100 may be generated by dissolving the monomers 104 and 106 in the mixture 102. The mixture 102 may include a carrier solvent (e.g., isopropyl alcohol (IPA)). The carrier solvent may be at least 3:1 by weight relative to the monomers 104 and 106. Fumed silica may be added (e.g., 3-15 wt %) to the mixture 102 based on the monomer mass. These materials may be mixed, for example, by shear mixing or sonication to form the composition 100. The composition 100 can then be cast as a thin film or as a layer on a substrate, on a waveguide, or other surface and may be cast in another appropriate shape.

The monomer 104 may include octadecylacrylate and may be polymerized by a radical process. The resulting polymer may be poly(octadecylacrylate) and may be a thermoplastic. Because the polymer resulting from the monomer 104 may be a thermoplastic, the polymer can be melted. The photoinitiator associated with the monomer 104 may be highly hydrophobic.

The monomer 106 may be a cationic monomer such as [Perfluorooctyl-2-(trifluoromethoxy)propyl]oxirane. Benzylpyridinium bromide or another more hydrophobic material may be added as a cationic thermal initiator that initiates polymerization of the monomer 106.

FIG. 1B illustrates an example of a structure that includes an optical component that has been formed from the material system illustrated in FIG. 1A. In one example, the composition may be arranged as a layer or a film on a waveguide (or other substrate) prior to forming the optical component. One or more optical components can be formed in the layer or on a surface of the layer. The area or volume of the optical component formed in in the layer may be smaller than the area or volume of the layer of the composition 100. Thus, the formation of an optical component can occupy an area or volume of the layer that is less than the entire area or volume of the layer. In addition, different optical components can be formed on different portions or in different locations of the same layer of the composition 100.

FIG. 1B illustrates an optical component 110 that has been formed in a layer of the composition 100. The optical component 110 may be an optical coupler or optical grating, for example. To form the optical component 110, the composition 100 may be exposed to a first polymerization mechanism. The first polymerization mechanism may be effective to polymerize or at least partially polymerize one of the monomers in the composition 100.

In one example, the first polymerization mechanism may include light at a particular wavelength. The light may be directed to the composition 100 at certain locations or regions. For example, the light may be configured in a pattern (e.g., an interference pattern) such that only certain regions of the composition 100 are exposed to the light. FIG. 1B illustrates regions 114 that are exposed to the light and regions 116 that are not exposed to the light.

The monomer (e.g., the monomer 104) in the composition that polymerizes in response to the light begins to polymerize in the regions 114. The polymerization of the monomer 104 in the regions 114 begins to deplete the monomers that are exposed to the light. As a result, additional monomers 104 in the regions 116 begin to diffuse into the region 114 in order to continue the polymerization process. At the same time, the second monomer (e.g., the monomer 106) diffuses away from the region 114 of polymerization and into the regions 116. The regions 114 are exposed to the light for a particular amount of time. The time can be determined by a user, by the thickness of the layer of the composition 100, by the degree of polymerization desired, or by other factors or combinations thereof.

After irradiation by the light, the region 114 exposed to the light may primarily include the polymerized monomer 104 or first polymer, and the region 116 that was not exposed to the light may primarily include the unpolymerized monomer 106. As previously stated, the monomer 104 or the first polymer may have a higher refractive index compared to the monomer 106 or vice versa. After exposer to the first polymerization mechanism, the resulting optical component 110 may include regions 114 that have a higher refractive index than the regions 116. By irradiating the composition 100 with the light in a pattern, the optical component 110 can be written into the composition 100. As a result, the arrangement or configuration of the optical component 110 may depend on the pattern of the light that is irradiated on the layer of the composition 100, and the optical component 110 may include a modulated refractive index.

In FIG. 1B, the optical component 110 has been irradiated with a pattern that results in an optical component with a modulated refractive index. In one example, the refractive index modulation (Δn) may be greater than 0.1 or greater than 0.2 or greater than 0.3 or greater 0.4 or greater than or equal to 0.5, as examples. In addition, the optical component 110 may have sub-micron resolution. In one example, the optical component 110 can be used to introduce optical signals into and extract optical signals out of a waveguide. The optical component 110 may be an optical test point, for example, that can be used for device testing or verification or other procedure. Because the optical component 110 is reconfigurable or erasable, as discussed below, the optical component 110 may not interfere (or may have reduced interference) with operation of the device.

FIG. 1C illustrates an example of the material system in FIG. 1B after the optical component has been reconfigured or removed from the layer. With reference to FIGS. 1B and 1C, the polymerized monomer, or first polymer, in the region 114 may include a thermoplastic. By heating the optical component 110 to a certain temperature, the thermoplastic may melt and mix with the monomer 106 that is substantially in the regions 116. For instance, the components of the optical component 110 may reflow in response to the applied heat. This reflow may result in a structure 120. Because the melted first polymer disperses and mixes with the monomer 106, the refractive index of the structure 120 may become substantially constant throughout the structure 120. The refractive index of the structure 120 may be an average of the refractive index of the monomer 106 and the refractive index of the first polymer. Thus, the structure 120 may include an average refractive index. Thus, the modulated refractive index of the optical component 110 has been removed or otherwise made less significant and the optical component 110 has been reconfigured or erased.

The reconfiguration of the structure 120, in one example, can be completed once the structure 120 is sufficiently mixed by polymerizing the second monomer 106. The second monomer 106 can be polymerized by a second polymerization mechanism. This can permanently fix the structure 120. The second polymerization mechanism may be optical or thermal, for example. FIGS. 1A-1C thus illustrate a system and process that allows an optical component to be written into an optical layer and then reconfigured in the optical layer.

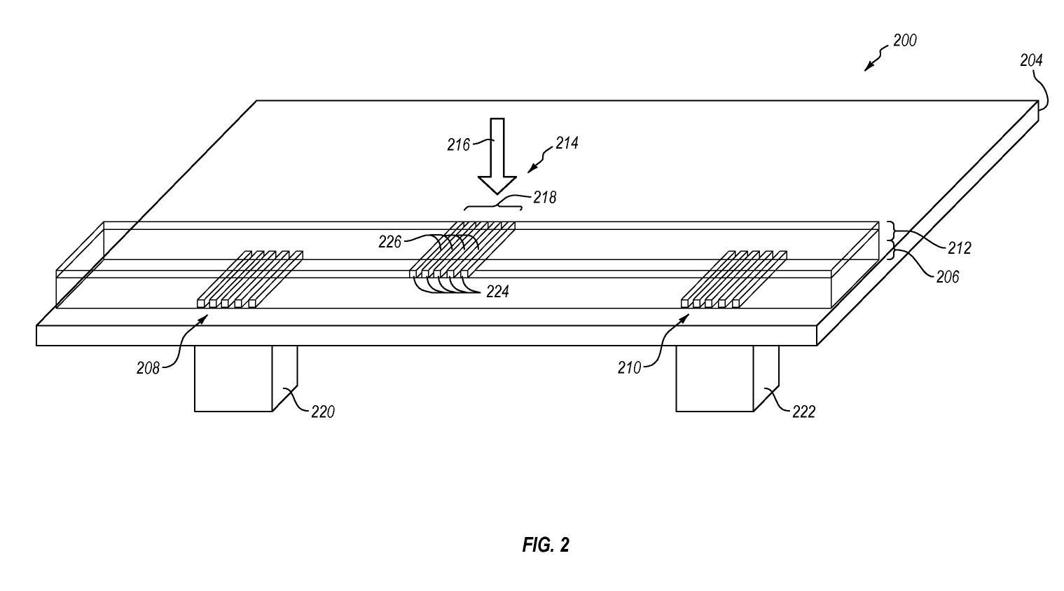

FIG. 2 illustrates an example of an optoelectronic device that includes a reconfigurable or erasable optical component. FIG. 2 illustrates a device 200 that may include optical and/or electrical components and/or optoelectrical interconnections. The device 200 may include a printed circuit board, an integrated circuit, or other device or structure.

The device 200 may include a first layer 204 and a second layer 206. The first layer 204 may include more than one layer. The layer 204 may include, by way of example, a substrate, a printed circuit board or the like. The device 200 may include various structures that allow optical signals to be converted to electrical signals and vice versa. Optoelectronic components 220 and 222 may be mounted on one surface of the layer 204. A layer 206 may be formed on a surface of the layer 204. The layer 206 may be on one side of the layer 204 and the optoelectronic components 220 and 222 may be mounted on an opposite side of the layer 204. In some examples, the optoelectronic components 220 and 222 may be on the same side of the layer 204 as the layer 206.

The layer 206 may be an optical structure such as an optical plane or an optical waveguide. The layer 206 may also include or couple to optical components 208 and 210. The optical components 208 and 210 may be optical gratings, for example. The optical component 208 may be configured to couple optical signals into and out of the optoelectronic component 220. Similarly, the optical component 210 may be configured to couple optical signals into and out of the optoelectronic component 222.

The optical components 208 and 210 can be used to route optical signals. For example, the optical components 208 and 210 and the layer 206 (an optical waveguide) allow a signal from the optoelectronic component 222 to be transmitted to or received from the optoelectronic component 220.

FIG. 2 also illustrates that the device 200 includes a layer 212. The layer 212 may include a thin film of a composition that has been cast or formed on the layer 206. The layer 212 may include a material system such as the composition 100.

After the layer 212 has been formed on the layer 206, the optical component 214 may be formed in the layer 212. More specifically, the optical component 214 may be formed in a region 218 of the layer 212. In this example, the optical component 214 may include a grating structure. The optical component 214 may be formed by a first polymerization mechanism that polymerizes one of the monomers in the layer 212 such that the optical component includes a modulated refractive index or such that the optical component has another structure.

The optical component 214 enables or otherwise allows light 216 to be introduced into the device 200 and/or extracted from the device 200. More specifically, the optical component 214 may allow the light 216 to be coupled into the layer 206. The layer 206 may deliver the light 216 to an optoelectronic component. Light could also be extracted from the layer 206 through the optical component 214. When the light 214 is introduced into or coupled to the component 212, the function and operation of the device 200 can be tested or validated, for example. For example, the optical component 214 can be used to determine whether the optoelectronic component 222 can receive/transmit optical signals through the optical component 210. This could verify an alignment of the optical component 210 relative to the component 222.

After the testing, validation, or other procedure is completed, the optical component 214 in the layer 212 can be removed or erased, in one example, by reconfiguring the optical component 214. In one example, reconfiguring the optical component can include annealing the optical component 214 such that regions 224 (which primarily include a polymerized first monomer) mix or reflow with regions 226 (which primarily include a second monomer). After the regions 224 and 226 have sufficiently mixed, the second monomer in the layer 212 may be polymerized. Annealing the layer 212 of the optical component and polymerizing the second monomer may effectively change the modulated refractive index to an average or constant refractive index. In this manner, the modulated refractive index of the optical component 214 may be removed and the optical component 214 may be effectively removed from the device 200.

In FIG. 2, the modulated refractive index of the optical component 214 may be changed such that the region 218 has an average or constant refractive index. By changing the refractive index of the region 218 such that the optical component 214 is reconfigured or removed, the optical component 214 (or remnant thereof) may not impact (or may have reduced impact on) the operation of the device 200. In one example, the layer 212 may remain on the device 200 after the second monomer is polymerized.

In one example, the first and second polymerization mechanisms can be applied only to the region 218. The first polymerization mechanism that results in the optical component 214 may only applied to the region 218. However, the second polymerization mechanism may be applied to more than the region 218 of the layer 212. In one example, the entire layer 212 may be fixed by polymerization of the second monomer.

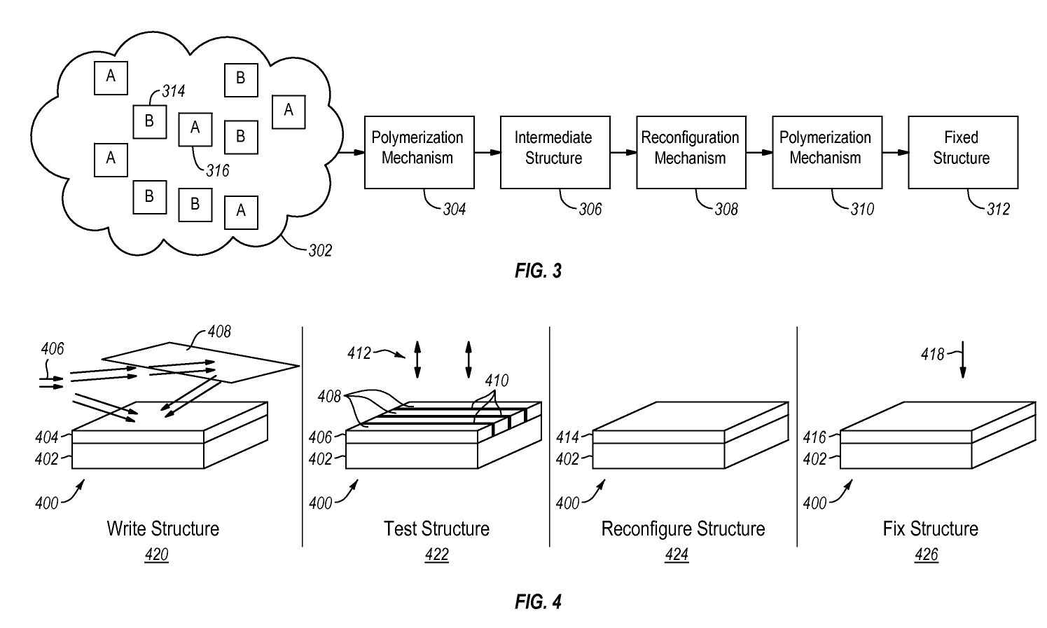

FIG. 3 illustrates an example of a system that transforms a material system into an intermediate structure that includes an optical component and then into a fixed structure where the optical component has been reconfigured or removed from the intermediate structure. FIG. 3 illustrates a composition 302 that may include monomers 314 and 316 and that may also include appropriate initiators for each of the monomers 314 and 316. The composition 302 may be formed, for example, into a thin layer on a substrate or on a structure such as a waveguide or optical plane. The composition 302 may be another example of a material system such as the composition 100.

After the composition 302 is arranged or deposited on a substrate, a polymerization mechanism 304 may be performed. The polymerization mechanism 304 may be configured to initiate polymerization of one of the monomers 314 and 316. In one example, the polymerization mechanism 304 may polymerize the first monomer 314 into a first polymer. The polymerization mechanism 304 may be light at a particular wavelength, for example, that is arranged in a pattern on a surface of the composition 302. The monomer 314 that is present in regions exposed to the light may polymerize as previously described. The first polymerization mechanism may produce or form an intermediate structure 306. The intermediate structure 306 may be an example of an optical component.

The intermediate structure 306 may have certain properties that enable the intermediate structure 306 to interact with optical signals in certain ways. The intermediate structure 306 may include a modulated refractive index, for example. The intermediate structure 306 may be mechanically stable and the device on which the intermediate structure 306 is formed can be tested. Optical signals can be introduced through and extracted from the intermediate structure 306.

When the intermediate structure 306 is no longer used, a reconfiguration mechanism 308 may be applied. In one example, the reconfiguration mechanism 308 may apply heat to the intermediate structure 308. The heat may be effective to melt the polymerized monomer (the first polymer) and may allow the melted polymer to mix with or reflow with the remaining monomer. This may effectively remove or reconfigure the intermediate structure 306 by removing the modulated refractive index.

After sufficient time has passed such that the first polymer and the second monomer are sufficiently mixed or have sufficiently reflowed, a second polymerization mechanism 310 may be performed. The polymerization of the monomer 316 effected by the second polymerization mechanism 310 may be optically initiated or thermally initiated. The remaining monomer 316 may be polymerized and may result in a fixed structure 312.

While the intermediate structure 306 may have a modulated refractive index, the fixed structure 312 may include an average refractive index (e.g., an average of the refractive index of the polymerized monomer 316 (the second polymer) and the first polymer). FIG. 3 further illustrates that examples of the optical components formed from the material systems disclosed herein may be writable a single time. The intermediate structure 306 may not be reformed from the fixed structure 312 in one example.

FIG. 4 illustrates an example of a configurable optical structure. More specifically, FIG. 4 illustrates an example of a configurable optical structure 400 of an optoelectronic device where an optical component is written into a layer of the waveguide and then removed from the waveguide.

The structure 400 may include a layer 402 and a layer 404. The layer 404 may be formed from a material system such as the composition 100. The composition may be cast on the layer 402. The layer 404 may have a certain thickness.

The layer 404 may include a nanoparticle gellant (or other gelling agent), a first monomer that is polymerizable by a first polymerization mechanism, and a second monomer that is polymerizable by a second polymerization mechanism. The first polymerization mechanism may include an optical mechanism. The second polymerization mechanism may include an optical mechanism or a thermal mechanism.

For example, the layer 404 may be configured to form an optical component in response to light that includes a particular wavelength. The light may polymerize the first monomer into a first polymer such that the composition includes a modulated refractive index. In one example, the layer 404 may also be heated to a first temperature such that the first monomer can flow within the composition. As previously stated, exposing the layer 402 to a light pattern may cause the first monomer in the regions exposed to light to polymerize. As the polymerization continues, the first monomer in regions that are not exposed to the light may diffuse into the regions exposed to the light while the second monomer may diffuse out of the regions exposed to the light. Because the layer 404 is heated to the first temperature, the first monomer and diffuse more easily into the regions exposed to the light.

The layer 402 or, more specifically the first polymer, may be further configured to melt when exposed to a second temperature that is higher than the first temperature. The first polymer may be a thermoplastic that melts at the second temperature. Once the first polymer is melted, the first polymer can mix with the unpolymerized second monomer in the layer 402. The melted first polymer and the second monomer mix.

Next, a permanent structure can be formed by exposure of the composition of the layer 404 to a second polymerization mechanism. The second polymerization mechanism can be either optically initiated or thermally initiated. When the second polymerization mechanism is optically initiated, the second monomer may be polymerized by exposure of the layer 404 to a second light including a second wavelength that is different from the first wavelength. When the second polymerization mechanism is thermally initiated, the second monomer may be polymerized by exposure of the layer 404 to a third temperature that is higher than or equal to the second temperature. The second monomer may polymerize at the third temperature and fix the structure. In one example, these temperatures may be lower than a reflow temperature of solder. This may enable the optical component to be reconfigured without adversely impacting electrical components or connections on the device.

When the polymerization mechanism is optically initiated, the frequency of the light may depend on the monomer and/or the associated initiator. In one example, the light may by near infrared light (NIR) or ultraviolet (UV). In one example, the light may have a wavelength of about 800 nm (NIR light). In another example, the light may have a wavelength of about 365 nm (UV light).

FIG. 4 further illustrates the transformation of the material system of the layer 404. Block 420 (“Write Structure”) illustrates that an optical component may be written into the layer 404. The optical component can be written using light 406 and/or a mirror 408 in one example. In one example, a grating pattern that includes parallel lines can be created using a coherent source and a computer-generated phase array or by constructively interfering the light with itself at opposing angles to form an interference pattern. Block 420 illustrates a pattern that may be formed by allowing a coherent source to interfere with itself.

In block 422 (“Test Structure”), an optical structure 406 has been formed in the layer 404. The optical structure 406 may include regions 408 that have a refractive index that is smaller than a refractive index of regions 410. However, the optical structure 406 and composition could be configured such that the regions 410 have the smaller refractive index. In this example, the first polymerization mechanism may be configured to polymerize the monomer having the smaller refractive index. The optical structure 406 allows light 412 to be coupled into and out of the layer 402 in one example.

In block 424 (“Reconfigure Structure”), the optical structure 406 has been reconfigured as a layer 414. Reconfiguring the optical structure 406 into the layer 414 may be performed by heating the layer 414 to a temperature that melts the first polymer in the regions 410, for example. The material in the regions 408 and 410 may reflow and mix such that the layer 414 has a refractive index that is not modulated or that is less modulated.

In block 426 (“Fix Structure”), the layer 416 may be permanently set. This can be performed by polymerizing the remaining unpolymerized monomer in the layer 416 with a polymerization mechanism 418. This can be accomplished using a thermally activated monomer or an optically activated monomer.

FIG. 4 further illustrates some of the changes that may occur in the layer 404. Initially, the layer 404 may include a material system such as the composition 100. The layer 404 may include a refractive index that is constant or substantially the same at all locations in the layer 404. The optical structure may be written into the layer such that the layer becomes the layer 406. The layer 406 may include a modulated refractive index. Plus, the material system may have changed because one of the monomers has been at least partially polymerized.

The layer 414, which may be formed by annealing the layer 406 or by melting the first polymer in the layer 406, also may have a refractive index. After the layer 414 has sufficient time to mix or reflow, the layer 414 may have refractive index that is constant or substantially the same at all locations in the layer 414. In one example, the time to thermally anneal the layer 406 may be less than one minute. In addition, the temperature may be compatible with solder reflow temperatures and printed circuit board materials. In one example, the temperature to melt the first polymer may be less than 250 degrees Celsius. For reflow to occur in less than one minute, by way of example only, the melted materials may have a diffusivity of about 10⁻¹² m²/s at the anneal temperature.

The refractive index of the layer 414 may the same as or different from the refractive index of the composition of the layer 402. The layer 416 may be distinct from the layer 414 because the second monomer has been polymerized. The refractive index of the layer 416 may be constant at substantially all locations of the layer 416 and may be different from the refractive index of the layer 414 and/or the layer 404. In one embodiment, the reconfiguring the structure may effectively reset the layer. Reconfiguring the structure can include annealing or heating the layer 414 and/or polymerizing the second monomer.

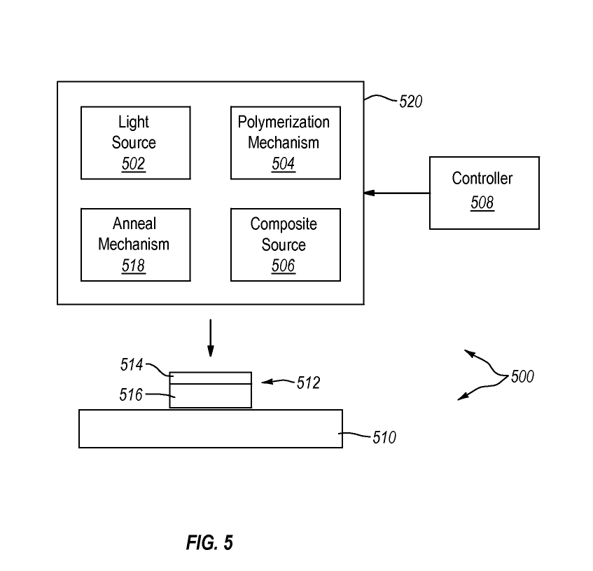

FIG. 5 illustrates an example of a system to form and to reconfigure optical components in an optical interconnect, such as an optical backplane for a printed circuit board. FIG. 5 shows an example system 500 that includes a controller 508, a light source 502, a polymerization mechanism 504, an annealing mechanism 518, and a composition source 506. The system 500 may cooperate to form a reconfigurable optical component in a waveguide 512 and to reconfigure the optical component.

More specifically, a waveguide 512 may be placed on a support structure 510, which may by a printed circuit board. The system 500 may include a substrate 516. The substrate 516 may be an optical backplane or an optical waveguide. The system 500 may be operative to form a layer 514 on the substrate 516 and to form and then reconfigure an optical component in the layer 514.

In one example, the controller 508 may be operatively coupled to or otherwise associated with the composition source 506. The controller 508 may control the composition source 506 such that a composition is placed on the layer 516 as the layer 514. The controller 508 may then control the light source 502 such that a pattern of light is irradiated on the layer 514. The pattern may include regions where light is present and regions where light is not present. The light source 502 is an example of a first polymerization mechanism. By irradiating the layer 514 with a light pattern, an optical component may be formed in the layer 514 that includes a modulated refractive index as previously described.

The components mounted on the support structure 510 may then be tested, validated, or subjected to other procedures that use the optical component formed in the layer 514. Once completed and the optical component formed in the layer 514 is no longer needed, the annealing mechanism 518 may apply heat to the layer 514 to melt the optical structure or, more specifically, to melt the first polymer that was formed in response to the light source 502 such that the layer 514 reflows. After the layer 514 reflows, the polymerization mechanism 504 may be used to polymerize the second monomer in the layer 514. After the second monomer is polymerized, the layer 514 is fixed.

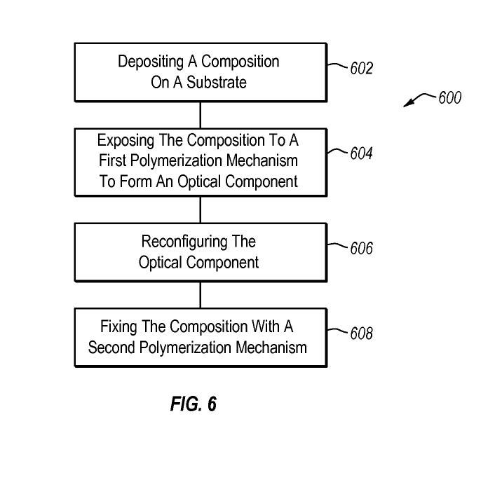

FIG. 6 illustrates a flow diagram of an embodiment of a method 600 to form and then reconfigure an optical component in a layer of an optoelectronic device. The method 600, and other methods and processes described herein, set forth various blocks or actions that may be described as processes, functional operations, events and/or acts, etc., which may be performed by hardware, software, firmware, and/or combination thereof.

The method 600 may include one or more operations as illustrated by blocks 602, 604, 606, and 608. In block 602 (“Depositing a Composition on a Substrate”), a composition may be deposited on a substrate. The composition, which may be an example of a material system, may include a first monomer, a second monomer, and a nanoparticle gellant or other gelling agent. The composition may also include an initiator for the first monomer and a second initiator for the second monomer.

In block 604 (“Exposing the Composition to a First Polymerization Mechanism to Form an Optical Component”), the composition may be subjected to a first polymerization mechanism. The first polymerization mechanism may include a wavelength of structured light that activates the first initiator such that the first monomer polymerizes into a first polymer. The structured light may have a pattern such that the composition is exposed to a pattern of structured light. In regions that are exposed to the structured light, the first monomer may polymerize. The regions that are not exposed to the structured light may contain a lesser amount of the first polymer. Exposing the composition to a first polymerization mechanism may generate an optical component that includes a modulated refractive index.

Block 604 may also include exposing or subjecting the composition to a first temperature that is at or above a melting point of the first monomer. Melting the first monomer may allow the first monomer to disperse into the regions that were not irradiated by the structured light while the second monomer may disperse into the regions that were irradiated.

In block 606 (“Reconfiguring the Optical Component”), the optical component may be reconfigured. The first polymer may be a thermoplastic. Reconfiguring the optical component may include melting the thermoplastic at a second temperature that is at or above a melting point of the first polymer. When the first polymer has melted, the first polymer and the second monomer may reflow. A reflow of the composition may change the refractive index such that the modulated refractive index is eliminated or otherwise made less significant.

In block 608 (“Fixing the Composition with a Second Polymerization Mechanism”), the composition may be fixed. In one example, the second polymerization may polymerize the second monomer into a second polymer. The second monomer may be polymerized thermally or optically. When the second monomer is thermally initiated, a temperature may be changed to or above a third temperature such that the second monomer polymerizes. When the second monomer is optically initiated, the composition may be exposed to a second wavelength of structured light. In one example, the entire composition may be irradiated such that the entire composition is polymerized and fixed. Fixing the composition may enable the refractive index to be fixed and substantially constant for all locations in the fixed composition.

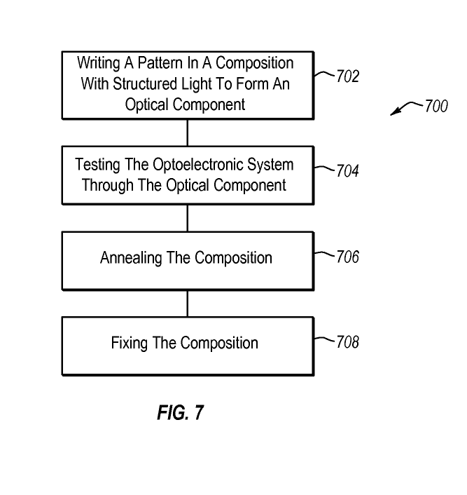

FIG. 7 illustrates a flow diagram of an embodiment of a method 700 to test an optoelectronic system. The method 700 may enable an optoelectronic device to be tested without the access ports interfering with the operation of the optoelectronic device after the tests have been completed.

In block 702 (“Writing a Pattern in a Composition with Structured Light to Form an Optical Component”), a composition may be exposed to structured light. The structured light may irradiate a composition, such as the composition 100 which may include a first monomer and a second monomer, with a pattern such that areas of comparatively high and low refractive indexes may be formed and an optical component may be formed in the composition. The light may polymerize the first monomer such that the optical component includes a modulated refractive index.

In block 704 (“Testing the Optoelectronic System Through the Optical Component”). The optical component may be formed such that a test light can be coupled into the optoelectronic system through the optical component that has been written into the composition. The optical component formed in the composition may also allow optical signals to be extracted from the optoelectronic system.

In block 704 (“Annealing the Composition”), the composition and more specifically the optical component may be annealed. An operation that anneals the composition may melt the polymerized monomer such that the composition reflows as previously described. In block 708 (“Fixing the Composition”), the composition may be fixed by polymerizing the second monomer after the composition reflows. The fixed composition may be a permanent part of the optoelectronic system or device, but may not have optical characteristics that can interfere with optical signals present in the optoelectronic system.

For this and other processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

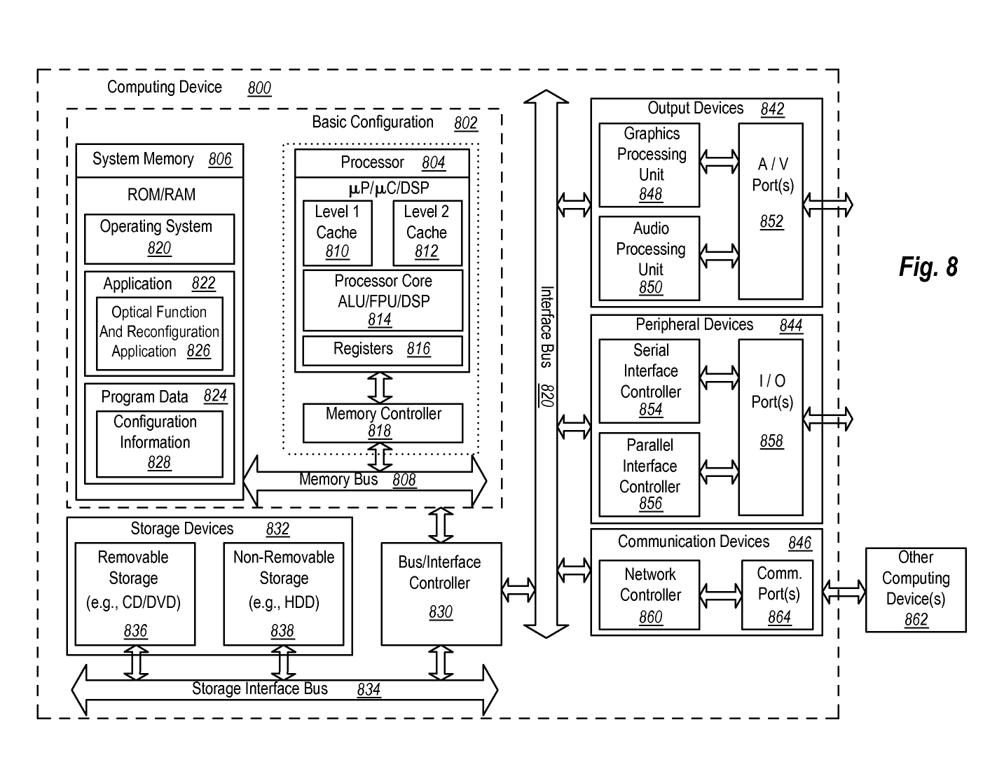

FIG. 8 shows an example computing device 800 that is configured to form and to reconfigure optical components in an optoelectronic system in accordance with the present disclosure. The computing device 800 may be configured to control, as illustrated in FIG. 5, the composite source 506, a polymerization mechanism 504, the anneal mechanism 518, the light source 502 or other components that contribute to forming and reconfiguring optical components in an optoelectronic system.

In one example, the computing device 800 may include components that communicate optically. Some of the components or modules of the computing device 800 may include waveguides and optical components that were reconfigured during various validation or testing procedures.

In a very basic configuration 802, computing device 800 generally includes one or more processors 804 and a system memory 806. A memory bus 808 may be used for communicating between processor 804 and system memory 806.

Depending on the desired configuration, processor 804 may be of any type including but not limited to a microprocessor (μP), a microcontroller (μC), a digital signal processor (DSP), or any combination thereof. Processor 804 may include one more levels of caching, such as a level one cache 810 and a level two cache 812, a processor core 814, and registers 816. An example processor core 814 may include an arithmetic logic unit (ALU), a floating point unit (FPU), a digital signal processing core (DSP Core), or any combination thereof. An example memory controller 818 may also be used with processor 804, or in some implementations memory controller 818 may be an internal part of processor 804. In one embodiment, the controller 508 of FIG. 5 may be embodied by the processor 804 and/or other components of the computing device 800.

Depending on the desired configuration, system memory 806 may be of any type including but not limited to volatile memory (such as RAM), non-volatile memory (such as ROM, flash memory, etc.) or any combination thereof. System memory 806 may include an operating system 820, one or more applications 822, and program data 824. Application 822 may include an optical formation and reconfiguration application 826 that is arranged to perform at least some of the operations as described herein including at least some of those described with respect to methods 600 and 700 in FIGS. 6 and 7. Program data 824 may include configuration information 828 that may be useful to form and reconfigure an optical component, and/or may include other information usable and/or generated by the various other modules/components described herein. The configuration information 828 may include temperatures, time periods, or other information, settings, etc. In some embodiments, application 822 may be arranged to operate with program data 824 on operating system 820 such that optical components are formed and reconfigured as described herein. This described basic configuration 802 is illustrated in FIG. 8 by those components within the inner dashed line.

Computing device 800 may have additional features or functionality, and additional interfaces to facilitate communications between basic configuration 802 and any required devices and interfaces. For example, a bus/interface controller 830 may be used to facilitate communications between basic configuration 802 and one or more data storage devices 832 via a storage interface bus 834. Data storage devices 832 may be removable storage devices 836, non-removable storage devices 838, or a combination thereof. Examples of removable storage and non-removable storage devices include magnetic disk devices such as flexible disk drives and hard-disk drives (HDDs), optical disk drives such as compact disk (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer readable instructions, data structures, program modules, or other data.

System memory 806, removable storage devices 836 and non-removable storage devices 838 are examples of computer storage media. Computer storage media includes, but is not limited to, RAM, ROM, EEPROM, flash memory or other memory technology, CD-ROM, digital versatile disks (DVDs) or other optical storage, magnetic cassettes, magnetic tape, magnetic disk storage or other magnetic storage devices, or any other medium which may be used to store the desired information and which may be accessed by computing device 800. Any such computer storage media may be part of computing device 800.

Computing device 800 may also include an interface bus 840 for facilitating communication from various interface devices (e.g., output devices 842, peripheral interfaces 844, and communication devices 846) to basic configuration 802 via bus/interface controller 830. Example output devices 842 include a graphics processing unit 848 and an audio processing unit 850, which may be configured to communicate to various external devices such as a display or speakers via one or more A/V ports 852. Example peripheral interfaces 844 include a serial interface controller 854 or a parallel interface controller 856, which may be configured to communicate with external devices such as input devices (e.g., keyboard, mouse, pen, voice input device, touch input device, etc.) or other peripheral devices (e.g., printer, scanner, etc.) via one or more I/O ports 858. An example communication device 846 includes a network controller 860, which may be arranged to facilitate communications with one or more other computing devices 862 over a network communication link via one or more communication ports 864.

The network communication link may be one example of a communication media. Communication media may generally be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 800 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 800 may also be implemented as a personal computer including both laptop computer and non-laptop computer configurations.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. This disclosure is not limited to particular methods, reagents, compounds compositions or biological systems, which can, of course, vary. The terminology used herein is for the purpose of describing particular embodiments only, and is not intended to be limiting.

In an illustrative embodiment, any of the operations, processes, etc. described herein can be implemented as computer-readable instructions stored on a non-transitory computer-readable medium. The computer-readable instructions can be executed by a processor of a mobile unit, a network element, and/or any other computing device.

The use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware are possible in light of this disclosure. In addition, the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those generally found in data computing/communication and/or network computing/communication systems.

The herein described subject matter sometimes illustrates different components contained within, or connected with, different other components. Such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, various embodiments of the present disclosure have been described herein for purposes of illustration, and various modifications may be made without departing from the scope and spirit of the present disclosure. Accordingly, the various embodiments disclosed herein are not intended to be limiting, with the true scope and spirit being indicated by the following claims.

What is claimed is:

1. A material system comprising:
a gellant agent;
a first monomer that is polymerizable into a first polymer by a first mechanism; and
a second monomer that is polymerizable into a second polymer by a second mechanism, wherein the gellant agent, the first monomer, and the second monomer are mixed to form a composition.

2. The material system of claim 1, wherein the first mechanism includes a photo-actuated mechanism and the second mechanism includes a thermal mechanism.

3. The material system of claim 1, wherein the gellant agent includes a nanoparticle gellant.

4. The material system of claim 3, wherein the nanoparticle gellant includes fumed silica.

5. The material system of claim 1, wherein the first monomer is polymerized by a radical process, wherein the first monomer includes octadecylacrylate and the first polymer includes poly(octadecylacrylate).

6. The material system of claim 1, wherein the second monomer includes a cationic monomer.

7. The material system of claim 6, wherein the second monomer includes [Perfluorooctyl-2-(trifluoromethoxy)propyl]oxirane, the material system further comprising a hydrophobic material as a cationic thermal initiator for the second monomer.

8. The material system of claim 1, wherein the composition is configured to form an optical component that includes a modulated refractive index in response to exposure to a first temperature and to structured light that includes a wavelength that initiates polymerization of the first monomer.

9. The material system of claim 8, wherein the optical component is reconfigured by exposure of the optical component to a second temperature that is higher than the first temperature, wherein exposure of the optical component to the second temperature removes the modulated refractive index such that the composition includes an average refractive index.

10. The material system of claim 9, wherein the composition is permanently fixed by exposure of the material to a third temperature that is higher than the second temperature, wherein polymerization of the second monomer is initiated at the third temperature.

11. The material system of claim 8, wherein the optical component includes a grating structure of an optical waveguide, or an optical coupler, and wherein modulation (Δn) of the refractive index of the optical component is greater than 0.01 or greater than 0.04.

12. The material system of claim 8, wherein the first mechanism includes a photo actuated mechanism and the second mechanism includes a photo actuated mechanism.

13. A configurable optical structure, the structure comprising:
a nanoparticle gellant;
a first monomer that is polymerizable by an optical mechanism that includes light at a particular wavelength;
a second monomer that is polymerizable by a thermal mechanism, wherein the first monomer and the second monomer are mixed with the nanoparticle gellant to form a composition,
wherein the composition is configured to:
form an optical component that includes a modulated refractive index in response to exposure to a first temperature and the light, wherein the first monomer polymerizes in response to the light;
melt in response to exposure to a second temperature that is higher than the first temperature such that the modulated refractive index is removed and the composition includes an average refractive index; and
form a permanent structure that includes the average refractive index by exposure of the composition to a third temperature that is higher than the second temperature, wherein the second monomer polymerizes at the third temperature.

14. The configurable optical structure of claim 13, wherein the first monomer includes octadecylacrylate, the second monomer includes [Perfluorooctyl-2-(trifluoromethoxy)propyl]oxirane, the nanoparticle gellant includes silica nanoparticles, and the composition includes a highly diffusive and mechanically stable matrix.

15. The configurable optical structure of claim 13, wherein the optical structure includes a grating structure.

16. The configurable optical structure of claim 15, wherein the grating structure includes a line width of less than 500 nm.

17. The configurable optical structure of claim 13, wherein the first temperature is higher than a melting temperature of the first monomer.

18. The configurable optical structure of claim 13, further comprising a hydrophobic photo initiator to initiate polymerization of the first monomer.

19. The configurable optical structure of claim 13, wherein the light includes a structured light.

20. A configurable optical structure, the structure comprising:
a nanoparticle gellant;
a first monomer that is polymerizable by a light that includes a first wavelength;
a second monomer that is polymerizable by a light that includes a second wavelength, wherein the first monomer and the second monomer are mixed with the nanoparticle gellant to form a composition,
wherein the composition is configured to:
form an optical component that includes a modulated refractive index in response to exposure to a first temperature and the first wavelength;
melt in response to exposure to a second temperature that is higher than the first temperature such that the modulated refractive index is removed and the composition includes an average refractive index; and
form a permanent structure that includes the average refractive index by exposure of the composition to the second wavelength while at the second temperature.

21. The configurable optical structure of claim 20, wherein the first monomer includes partially fluorinated acrylate, the second monomer includes a liquid oxirane, and the nanoparticle gellant includes silica nanoparticles, and the composition includes a highly diffusive and mechanically stable matrix.

22. The configurable optical structure of claim 20, wherein:
the optical component includes a grating structure,
the grating structure includes a line width of less than 500 nm, and the first temperature is higher than a melting temperature of the first monomer.

23. The configurable optical structure of claim 20, further comprising a nitrite reductase (NIR)-active radical photo initiator and an ultraviolet (UV)-active cationic photo initiator.

24. An apparatus comprising:
a substrate;
an optical backplane formed on a surface of the substrate; and
a reconfigurable optical structure formed on the optical backplane, wherein the reconfigurable optical structure comprises a composition of a first monomer, a second monomer, and a nanoparticle gellant, wherein the composition is configured to:
form an optical component that includes a modulated refractive index in response to exposure to a first temperature and a first wavelength of structured light, wherein the first wavelength of light causes the first monomer to polymerize into a first polymer; and
reconfigure the optical component in response to a second temperature that is higher than the first temperature such that the modulated refractive index is removed and the optical component includes an average refractive index.

25. The apparatus of claim 24, wherein the composition is further configured to form a permanent fixed structure that includes the average refractive index in response to exposure to a third temperature that is higher than the second temperature, wherein the second monomer polymerizes at the third temperature.

26. The apparatus of claim 24, wherein the composition is further configured to form a permanent fixed structure that includes the average refractive index in response to exposure to the second wavelength of light while the composition is at the second temperature, wherein the second wavelength of light polymerizes the second monomer.

27. The apparatus of claim 24, wherein the substrate includes a printed circuit board, or an integrated circuit, or a structure that include optical and/or electrical components.

28. The apparatus of claim 24, wherein the optical component includes a grating structure or a waveguide and the composition is formed as a layer on the optical backplane.

29. The apparatus of claim 28, wherein the optical component is formed on a particular area of the layer.

30. The apparatus of claim 24, wherein the composition includes a first photo initiator and a second photo initiator.

31. The apparatus of claim 24, wherein the optical component is configured to enable the optical backplane to be tested or verified by introduction of light into and out of the optical backplane.
